(19) United States
(12) Patent Application Publication
(10) Pub. No.: US 2026/0108979 A1
(43) Pub. Date: Apr. 23, 2026

(54) LASER MACHINING APPARATUS FOR FORMING VARIOUS MACHINING PATTERNS AND LASER MACHINING METHOD USING THE SAME

(71) Applicant: MEERE COMPANY INC., Hwaseong-si Gyeonggi-do (KR)

(72) Inventors: Joon Jung LEE, Anyang-si Gyeonggi-do (KR); Bong Don LEE, Gunpo-si Gyeonggi-do (KR)

(73) Assignee: MEERE COMPANY INC., Hwaseong-si Gyeonggi-do (KR)

(21) Appl. No.: 19/362,795

(22) Filed: Oct. 20, 2025

(30) Foreign Application Priority Data
Oct. 22, 2024 (KR) 10-2024-0145244
Sep. 29, 2025 (KR) 10-2025-0140886

(51) Int. Cl. B23K 26/046; B23K 26/03; B23K 26/06; B23K 26/067; B23K 26/073; B23K 26/36

(52) U.S. Cl. CPC B23K 26/046; B23K 26/032; B23K 26/0626; B23K 26/0648; B23K 26/0676; B23K 26/073; B23K 26/36

(57) ABSTRACT

A laser machining apparatus comprises an optical unit including a first optical group including a plurality of first diffractive optical elements configured to convert a shape of a laser beam, a second optical group including a plurality of second diffractive optical elements configured to branch the laser beam into multiple beams, an optical element holder configured to select diffractive optical elements from the first and second optical groups, arrange the selected diffractive optical elements in series with respect to an optical axis of the laser beam, and combine them, and a lens unit configured to focus the laser beam on a surface of a workpiece, and a controller configured to control the optical element holder, receive machining pattern data, determine a machining parameter according to the input machining pattern data, and select a combination of the first and second diffractive optical elements corresponding to the determined machining parameter.

### CROSS-REFERENCE TO RELATED APPLICATIONS

This application claims priority under 35 U.S. C. § 119 to Korean Patent Application No. 10-2024-0145244, filed on Oct. 22, 2024, and Korean Patent Application No. 10-2025-0140886, filed on Sep. 29, 2025, in the Korean Intellectual Property Office, the disclosure of which is incorporated by reference herein in its entirety.

### BACKGROUND

### 1. Field

The disclosure relates to a laser machining apparatus for use in semiconductor or display machining and a laser machining method using the same.

### 2. Description of the Related Art

When machining semiconductor substrates or display elements, laser patterning may be performed to precisely form desired patterns by selectively removing materials from the surfaces of workpieces through laser ablation. In a semiconductor chip dicing or chip packaging process, or in a display substrate sawing process, laser grooving may be performed to form precise grooves in a workpiece.

In a laser machining apparatus which performs laser machining, laser beam patterns to be irradiated onto a workpiece have to be changed according to the type of workpiece to be laser-machined, the specifications and shape of the form to be machined, processing methods, or the like. To this end, the type and size of an optical unit included in the laser machining apparatus also have to be changed.

However, changing the optical unit according to various machining specifications has technical limitations and also causes a decrease in production yield, a deterioration in machining quality, an increase in machining defects, and cost issues. This is because the configuration of the optical unit is very complicated, and in case that a plurality of components included in the optical unit are changed and manipulated so as to satisfy various machining specifications, problems such as a deterioration in machining quality and machining defects occur due to aberrations caused by the plurality of components included in the optical unit, which lowers the production yield.

### SUMMARY

The disclosure provides a laser machining apparatus including an optical unit configured to form various machining patterns, and a laser machining method using the same. The objectives to be achieved by the disclosure are not limited to those described above, and other objectives may be inferred from the following embodiments.

According to an aspect of the disclosure, a laser machining apparatus includes a laser oscillator configured to generate a laser beam, an optical unit configured to control the laser beam and irradiate the controlled laser beam onto a surface of a workpiece, the optical unit including a) a first optical group including a plurality of first diffractive optical elements configured to convert a shape of the laser beam, b) a second optical group including a plurality of second diffractive optical elements configured to branch the laser beam into multiple beams, c) an optical element holder configured to select diffractive optical elements from the first optical group and the second optical group, arrange the selected diffractive optical elements in series with respect to an optical axis of the laser beam, and combine the diffractive optical elements, and d) a lens unit configured to focus the laser beam on the surface of the workpiece, a machining table configured to move the workpiece in a machining direction, and a controller configured to control the optical element holder to receive machining pattern data, determine a machining parameter according to the input machining pattern data, and select a combination of the first diffractive optical element and the second diffractive optical element corresponding to the determined machining parameter.

The laser machining apparatus may further include a laser attenuator configured to control output intensity of the laser beam.

The first optical group may further include a blank configured to allow the laser beam to pass, and the plurality of first diffractive optical elements may include a top-hat diffractive optical element configured to convert the laser beam into at least one of a line shape, a rectangle shape, or a square shape.

The second optical group may further include a blank configured to allow the laser beam to pass, and the plurality of second diffractive optical elements may include a multi-spot diffractive optical element configured to branch the laser beam into multiple beams and differently implement a number of multiple beams.

The optical element holder may include a rotating turret or a sliding mechanism capable of selectively arranging the diffractive optical elements of the first optical group and the second optical group.

The lens unit may include a plurality of objective lenses having different magnifications, the laser machining apparatus may further include a lens holder configured to arrange an objective lens selected from the lens unit in series with the selected diffractive optical element with respect to an optical axis and combine the objective lens and the selected diffractive optical element, and the controller may be further configured to control the lens holder to select an objective lens corresponding to the determined machining parameter.

The plurality of objective lenses may include at least an objective lens having a 5× magnification and an objective lens having a 10× magnification.

The machining pattern data may include a machining line width and a machining depth, and the machining parameter may include at least a shape of the laser beam and a number of multiple beams.

The controller may be further configured to determine a rotation angle of the first diffractive optical element selected according to the input machining pattern data, and control the first diffractive optical element to rotate with respect to a rotation axis parallel to a normal line of a plane of the workpiece according to the determined rotation angle.

The laser machining apparatus may further include a beam limiting element arranged between the first optical group and the lens unit and configured to block a portion of the laser beam, wherein the beam limiting element may include a slit or an aperture, and the controller may be further configured to determine a laser beam blocking range based on the rotation angle and control the beam limiting element based on the determined laser beam blocking range.

The laser machining apparatus may further include a camera configured to obtain a real-time image through a same path as a path along which the laser beam is irradiated.

According to another aspect of the disclosure, a laser machining method using the laser machining apparatus includes a) receiving machining pattern data and determining a machining parameter, by the controller, b) controlling, by the controller, a combination of a first diffractive optical element and a second diffractive optical element according to the machining parameter, and c) controlling the laser oscillator to output a laser beam and forming a machining pattern on the workpiece by performing control so that the laser beam controlled through the selected first diffractive optical element and the selected second diffractive optical element is irradiated onto the surface of the workpiece W, by the controller.

In case that, in operation a), the controller receives first machining pattern data for machining a first machining pattern having a first machining line width and a first machining depth, the controller may be configured to, in operation b), control the optical element holder to select a first top-hat diffractive optical element, which converts the laser beam into a line beam having a first length, as the first diffractive optical element, select a first multi-spot diffractive optical element, which branches the line beam into a first number of multiple beams, as the second diffractive optical element, and combine the selected first top-hat diffractive optical element and the first multi-spot diffractive optical element, and the multiple beams may be arranged in parallel in a machining direction.

In case that, in operation a), the controller receives second machining pattern data for machining a second machining pattern having a first machining line width and a second machining depth different from the first machining depth (for example, greater than the first machining depth), the controller may be further configured to, in operation b), control the optical element holder to select a first top-hat diffractive optical element, which converts the laser beam into a line beam having a first length, as the first diffractive optical element, select a second multi-spot diffractive optical element, which branches the line beam into a second number of multiple beams, as the second diffractive optical element, and combine the selected first top-hat diffractive optical element and the second multi-spot diffractive optical element, and the second number may be different from the first number (for example, greater than the first number).

In case that, in operation a), the controller receives third machining pattern data for machining a third machining pattern having a second machining line width different from the first machining line width (for example, less than the first machining line width) and the first machining depth, the controller may be further configured to, in operation b), control the optical element holder to select a second top-hat diffractive optical element, which converts the laser beam into a line beam having a second length, as the first diffractive optical element, select a first multi-spot diffractive optical element, which branches the line beam into a first number of multiple beams, as the second diffractive optical element, and combine the selected second top-hat diffractive optical element and the first multi-spot diffractive optical element, and the second length may be different from the first length (for example, less than the first length).

In case that, in operation a), the controller receives fourth machining pattern data for machining a fourth machining pattern having a third machining line width less than the first machining line width and a third machining depth greater than the first machining depth, the controller may be further configured to, in operation b), control the optical element holder to select a blank, which allows the laser beam to pass, from the first optical group, select a first multi-spot diffractive optical element, which branches the line beam into a first number of multiple beams, as the second diffractive optical element, and combine the selected blank and the selected first multi-spot diffractive optical element.

A lens unit may include a plurality of objective lenses having different magnifications, the laser machining apparatus may further include a lens holder configured to arrange an objective lens selected from the lens unit in series with the selected diffractive optical element with respect to an optical axis and combine the objective lens and the selected diffractive optical element, and the laser machining method may further include, in operation b), performing, by the controller, control to select an objective lens according to the machining parameter.

The laser machining method may further include determining a rotation angle of the first diffractive optical element selected according to the input machining pattern data, and controlling the first diffractive optical element to rotate with respect to a rotation axis parallel to a normal line of a plane of a workpiece according to the determined rotation angle, by the controller.

The laser machining apparatus may further include a beam limiting element arranged between the first optical group and the lens unit and configured to block a portion of the laser beam, and the laser machining method may further include determining a laser beam blocking range based on the rotation angle and controlling the beam limiting element based on the determined laser beam blocking range, by the controller.

The laser machining apparatus may further include a camera configured to obtain a real-time image through a same path as a path along which the laser beam is irradiated, and the laser machining method may further include identifying, by the controller, alignment of the first diffractive optical element and the second diffractive optical element in real time.

### BRIEF DESCRIPTION OF THE DRAWINGS

The above and other aspects, features, and advantages of certain embodiments of the disclosure will be more apparent from the following description taken in conjunction with the accompanying drawings in which:

FIG. 1 is a diagram illustrating a laser machining apparatus according to an embodiment;

FIGS. 2A and 2B are diagrams illustrating an optical unit according to an embodiment;

FIG. 3 is a flowchart illustrating a laser machining method using the laser machining apparatus of FIG. 1;

FIGS. 4A, 4B, 4C, and 4D are diagrams illustrating an embodiment of a laser machining method of forming various machining patterns by using the laser machining apparatus of FIG. 1;

FIGS. 5A, 5B, 5C, and 5D are diagrams illustrating another embodiment of a laser machining method of forming various machining patterns by using the laser machining apparatus of FIG. 1;

FIGS. 6A, 6B, 6C, and 6D are diagrams illustrating another embodiment of a laser machining method of forming various machining patterns by using the laser machining apparatus of FIG. 1;

FIG. 7 is a diagram illustrating a laser machining apparatus according to another embodiment;

FIG. 8 is a flowchart illustrating a laser machining method using the laser machining apparatus of FIG. 7;

FIGS. 9A, 9B, 9C, and 9D are diagrams illustrating an embodiment of a laser machining method of forming various machining patterns by using the laser machining apparatus of FIG. 7;

FIGS. 10A, 10B, 10C are images obtained by capturing rotation of a laser beam by the laser machining apparatus of FIG. 7;

FIG. 11 is a diagram illustrating a laser machining apparatus according to another embodiment;

FIG. 12 is a flowchart illustrating a laser machining method using the laser machining apparatus of FIG. 11; and

FIGS. 13A, 13B, 13C, and 13D are diagrams illustrating an embodiment of a laser machining method of forming various machining patterns by using the laser machining apparatus of FIG. 11.

### DETAILED DESCRIPTION

Hereinafter, embodiments of the disclosure will be described with reference to the accompanying drawings, so that those of ordinary skill in the art may easily carry out the disclosure. However, the disclosure may be implemented in various different forms and is not limited to embodiments described herein. To clearly explain the disclosure, parts irrelevant to the description are omitted in the drawings and similar reference numerals are assigned to similar parts throughout the specification.

In the following embodiments, the terms “first,” “second,” etc. are not used in a restrictive sense and are used to distinguish one element from another.

The singular forms as used herein are intended to include the plural forms as well unless the context clearly indicates otherwise.

It will be understood that the terms “include” and/or “comprise” as used herein specify the presence of stated features or elements, but do not preclude the presence or addition of one or more other features or elements.

In the following embodiments, it will be understood that, when a portion such as layer, region, or element is referred to as being “on” another portion, this may include not only a case where the portion is directly on the other portion, but also a case where intervening layers, regions, or elements may be present therebetween.

Furthermore, sizes of elements in the drawings may be exaggerated or reduced for convenience of explanation. For example, because sizes and thicknesses of elements in the drawings are arbitrarily illustrated for convenience of explanation, the disclosure is not necessarily limited thereto.

The x-axis, DR1, DR2, and DR3 are not limited to three axes of the orthogonal coordinate system and may be interpreted in a broader sense. For example, DR1, DR2, and DR3 may be perpendicular to one another or may represent different directions which are not perpendicular to one another.

In case that a certain embodiment is implemented differently, a sequence of a machining method may be performed differently from a sequence described herein. For example, two consecutively described operations may be performed substantially at the same time or performed in an order opposite to the stated order.

The disclosure will be described in detail with reference to the accompanying drawings.

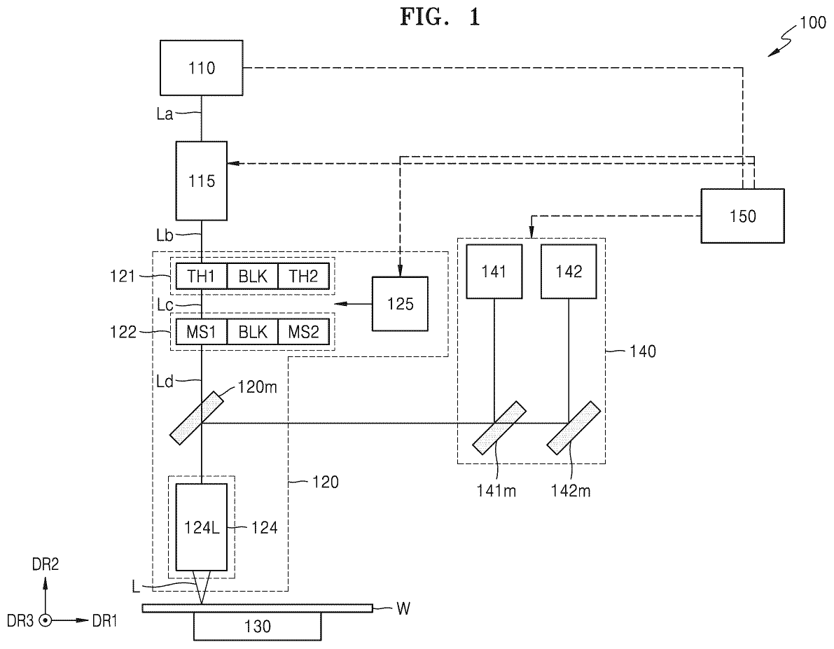

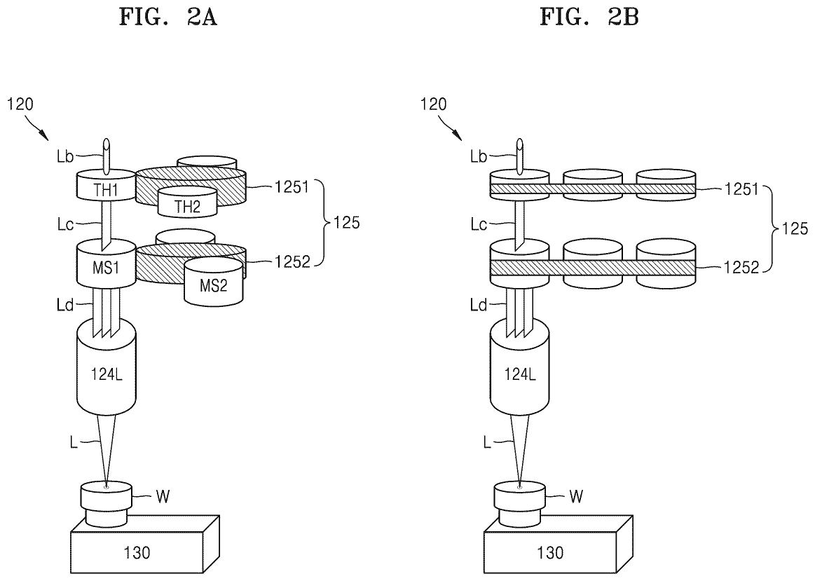

FIG. 1 is a diagram illustrating a laser machining apparatus 100 according to an embodiment. FIG. 2 is a diagram illustrating an optical unit 120 according to an embodiment.

Referring to FIG. 1, the laser machining apparatus 100 may include a laser oscillator 110, a laser attenuator 115, the optical unit 120, a machining table 130, a coaxial optical system 140, and a controller 150.

The laser oscillator 110 may generate a laser beam La. The laser beam La generated by the laser oscillator 110 may be a single spot laser beam having a Gaussian profile. In FIG. 1, the laser beam generated by the laser oscillator 110 is denoted by La.

The laser oscillator 110 may include a laser source which generates and outputs a laser beam having a particular wavelength. The type of laser beam output from the laser oscillator 110 is not particularly limited and may be appropriately selected depending on the type or machining method of a workpiece W. For example, the laser beam output from the laser oscillator 110 may be any one of a solid laser beam including a ruby laser beam, a neodymium (Nd):yttrium aluminum garnet (YAG) laser beam, a titanium (Ti):sapphire laser beam, or the like, a liquid laser beam including a dye laser beam or the like, a gas laser beam including a carbon dioxide (CO₂) laser beam, a helium (He)-neon (Ne) laser beam, an argon ion (Ar+) laser beam, an excimer laser beam, or the like, and an ultraviolet (UV) laser beam. The laser oscillator 110 may be connected to the controller 150. Characteristics of the laser beam output from the laser oscillator 110, for example, the wavelength, mode (continuous wave or pulse wave), and the like of the laser beam, may be controlled by signals which are generated by the controller 150.

The laser attenuator 115 may control the output intensity of the laser beam La generated by the laser oscillator 110. The output intensity of the laser beam refers to the total energy of the laser emitted from the laser oscillator 110, which is expressed in units of watts (W) or milliwatts (mW) per hour. In FIG. 1, the laser beam, the output intensity of which is controlled by the laser attenuator 115, is denoted by Lb. The laser attenuator 115 may prevent damage to the workpiece due to excessive output of the laser beam when machining the workpiece, and may optimize machining quality by precisely controlling the intensity of the laser beam. The laser attenuator 115 may be controlled by signals which are generated by the controller 150.

The optical unit 120 may include a first optical group 121, a second optical group 122, an optical element holder 125, and a lens unit 124. The optical unit 120 may control the laser beam Lb output from the laser attenuator 115 so as to irradiate a laser beam L onto a desired position on the surface of the workpiece W. The operation of the optical unit 120 may be controlled by the controller 150.

The first optical group 121 may be arranged between the laser oscillator 110 and the second optical group 122 with respect to an optical axis. The first optical group 121 may provide a laser beam Lc obtained by changing the shape of the laser beam Lb, the output intensity of which is controlled by the laser attenuator 115. To this end, the first optical group 121 may include a plurality of first diffractive optical elements (DOEs) which change the shape of the laser beam. Each of the first DOEs may be a top-hat DOE (TH DOE) which converts a laser beam into laser beams having different shapes. For example, a first TH DOE TH1 may be an element which converts a laser beam into a line beam having a line shape, a second TH DOE TH2 may be an element which converts a laser beam into a rectangular shape, and a third TH DOE (not shown) may be an element which converts a laser beam into a square shape. Accordingly, the first optical group 121 may include various TH DOEs so that desired beam shapes may be selectively used depending on machining conditions.

In some embodiments, the first optical group 121 may include, in addition to the TH DOEs, a blank BLK which allows a laser beam to pass. The blank BLK may be a flat transparent element without any pattern and may allow a laser beam to pass straight without scattering or diffracting.

The second optical group 122 may be arranged between the first optical group 121 and the lens unit 124 with respect to the optical axis. The second optical group 122 may branch the laser beam Lc having passed through the first optical group 121 and may provide a branched laser beam Ld. The second optical group 122 may include a plurality of second DOEs having a variable number of branching of the laser beam. Each of the second DOEs may be a multi-spot DOE (MS DOE) which converts a laser beam into multiple beams having different numbers of branched beams. For example, a first MS DOE MS1 may be an element which converts a laser beam into five multi-beams having a certain pitch (interval) in a one-dimensional beam array (1×N, where N is a natural number), a second MS DOE MS2 may be an element which converts a laser beam into eight multi-beams having a certain pitch in a one-dimensional beam array (1×N), and a third MS DOE (not shown) may be an element which converts a laser beam into eleven multi-beams having a certain pitch in a one-dimensional beam array (1×N). In the disclosure, the number of beams branched by the MS DOEs may be two, three, tens, hundreds, or tens of thousands in the one-dimensional beam array (1×N). In some embodiments, in the disclosure, the beams branched by the MS DOEs may be a two-dimensional beam array (M×N, where M and N are natural numbers) as well as the one-dimensional beam matrix (1×N). Accordingly, the second optical group 122 may include various MS DOEs so that desired multiple beams may be selectively used depending on machining conditions.

In some embodiments, the second optical group 122 may further include, in addition to the MS DOEs, a blank BLK which allows a laser beam to pass.

The optical element holder 125 may select DOEs from the first optical group 121 and the second optical group 122 and combine the selected DOEs. For example, the optical element holder 125 may select one first DOE (or blank BLK) from the first optical group 121 and may select one second DOE (or blank BLK) from the second optical group 122. The optical element holder 125 may arrange the two selected DOEs in series with respect to the optical axis of the laser beam and combine the two selected DOEs. The optical element holder 125 may be controlled by signals which are generated by the controller 150.

Referring to FIGS. 2A and 2B, the optical element holder 125 may include a first optical element holder 1251 and a second optical element holder 1252. The first optical element holder 1251 may select one first DOE (or blank BLK) from the first optical group 121 and arrange the selected first DOE along the optical axis of the laser beam. The first optical element holder 1251 may include a rotating turret as in FIG. 2A, or may include a sliding mechanism as in FIG. 2B. The second optical element holder 1252 may select one second DOE (or blank BLK) from the second optical group 122 and arrange the selected second DOE along the optical axis of the laser beam. The second optical element holder 1252 may include a rotating turret as in FIG. 2A, or may include a sliding mechanism as in FIG. 2B. In another embodiment, the first optical element holder 1251 and the second optical element holder 1252 may be integrally formed as a single body. In another embodiment, the first optical element holder 1251 may include a rotating turret and the second optical element holder 1252 may include a sliding mechanism, or vice versa.

The laser machining apparatus 100 according to an embodiment may combine different types of DOEs (or blanks BLK) within the single optical unit 120 through the optical element holder 125, and may form various line widths and depths of the machining pattern with the single optical unit 120.

The lens unit 124 may be arranged between the second optical group 122 and the machining table 130 with respect to the optical axis. The lens unit 124 may control the size of the branched laser beam Ld and provide a laser beam L, the size of which is controlled. The lens unit 124 may include an objective lens 124L. The objective lens 124L may control the size of the laser beam and focus the laser beam on the surface of the workpiece W. The objective lens 124L may control the size of the laser beam at a set magnification. The magnification of the objective lens 124L may be 5× to reduce the laser beam to ⅕, 10× to reduce the laser beam to 1/10, 20× to reduce the laser beam to 1/20, or the like.

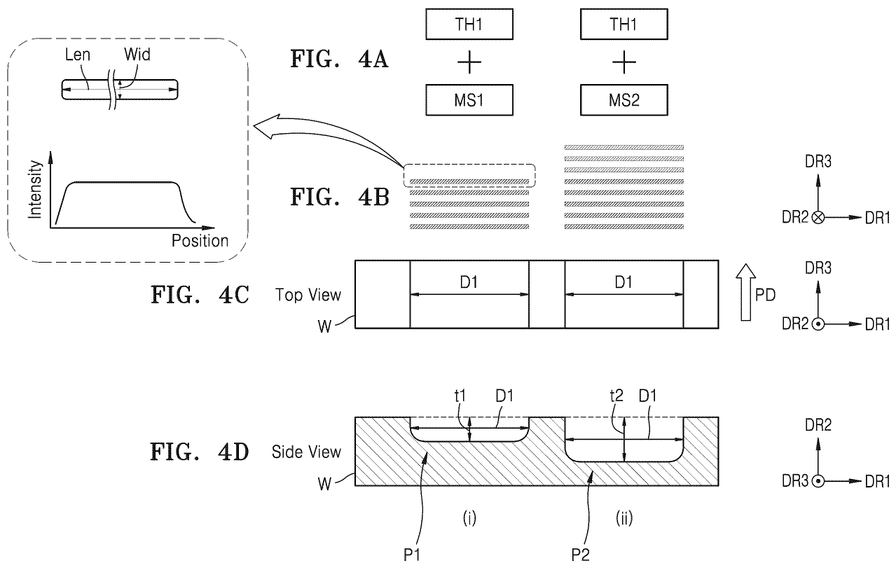

The machining table 130 may be arranged in a direction in which the laser beam is irradiated. The workpiece W may be seated on the machining table 130. The machining table 130 may move the workpiece W in a machining direction (see PD of FIGS. 4A-4D). For example, the machining table 130 may move the workpiece W in each direction, such as DR1, DR2, or DR3. The operation of the machining table 130 may be controlled by the controller 150.

The coaxial optical system 140 may align an optical path and a vision path of the laser beam into one, so that a camera 141 image may be obtained through the same path as the path along which the laser beam is irradiated. The coaxial optical system 140 may enable real-time machining observation and precise alignment monitoring of the optical unit 120 because a laser irradiation position coincides with an observation position of the camera 141. For example, the coaxial optical system 140 may enable precise alignment monitoring when arranging the DOEs selected from the first optical group 121 and the second optical group 122 in series with respect to the optical axis of the laser beam and combining the DOEs. In some embodiments, the coaxial optical system 140 may enable real-time machining observation because there is no movement time due to offset between machining and vision.

The coaxial optical system 140 may include a coaxial illuminator 142, one or more mirrors 141m, 142m, and 120m, and the camera 141.

The coaxial illuminator 142 may provide light required for the camera 141 to obtain images or videos. The coaxial illuminator 142 may include a light-emitting diode (LED) light source. The coaxial illuminator 142 may combine pieces of light onto the optical axis through the one or more mirrors 141m, 142m, and 120m so that light is incident on the same path as the field of view of the camera 141.

The one or more mirrors 141m, 142m, and 120m may include a coaxial illuminator mirror 142m which combines the coaxial illuminator 142 into the optical axis, an optical mirror 120m which makes light reflected from the workpiece W incident on the optical unit 120 and combines the light into the optical axis, and a camera mirror 141m which makes light combined into the optical axis incident on the camera 141. The type and number of mirrors may vary depending on a device. Each of the optical mirror 120m and the camera mirror 141m may be a half mirror (beam splitter) which reflects a portion of the incident light and transmits a portion of the incident light, unlike the coaxial illuminator mirror 142m.

The camera 141 may monitor a machining position onto which the laser beam is irradiated. The camera 141 may obtain real-time images through the same path as the path along which the laser beam is irradiated. To this end, the light irradiated by the coaxial illuminator 142 is reflected from the surface of the workpiece W, is incident on the optical unit 120, and reaches the camera 141 through the mirror or the like. In this manner, an image or video is generated. Before machining the workpiece W, the camera 141 may generate image or video information for aligning the DOEs selected from the first optical group 121 and the second optical group 122. In some embodiments, during the machining of the workpiece W, the camera 141 may generate image or video information including a trajectory along which the laser beam moves, an irradiation position, and a machining result.

For example, the camera 141 identifies that the DOEs selected from the first optical group 121 and the second optical group 122 are arranged and aligned in series with respect to the optical axis of the laser beam. The camera 141 may be controlled by the controller 150, and information such as images or videos obtained from the camera 141 may be transmitted to the controller 150. The controller 150 may precisely control the positions of the selected DOEs by controlling the optical element holder 125 based on the received information. In some embodiments, the camera 141 may identify the surface of the workpiece W, onto which the laser beam is irradiated, in real time. The controller 150 may identify, based on the received information, whether the machining line width and machining depth of the machining pattern match input machining pattern data.

In general, the laser machining apparatus uses a “separate optical system” in which machining and observation are separated from each other. However, in the case of the separate optical system, it is difficult to precisely identify whether the DOEs selected from the first optical group 121 and the second optical group 122 are combined and aligned accurately, and real-time machining observation is impossible. However, according to an embodiment, because the laser machining apparatus 100 includes the coaxial optical system 140, there is an effect of achieving real-time machining observation and accurate alignment of the combination of the plurality of DOEs.

The controller 150 may control the respective components of the laser machining apparatus 100. The controller 150, which acts as a processor, may be implemented by including at least one of application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electrical units for performing functions.

According to an embodiment, the controller 150 may control the optical element holder 125 to receive machining pattern data, determine machining parameters according to input machining pattern data, and select a combination of the first DOE and the second DOE corresponding to the determined machining parameters. A specific operation of the controller 150 is described below.

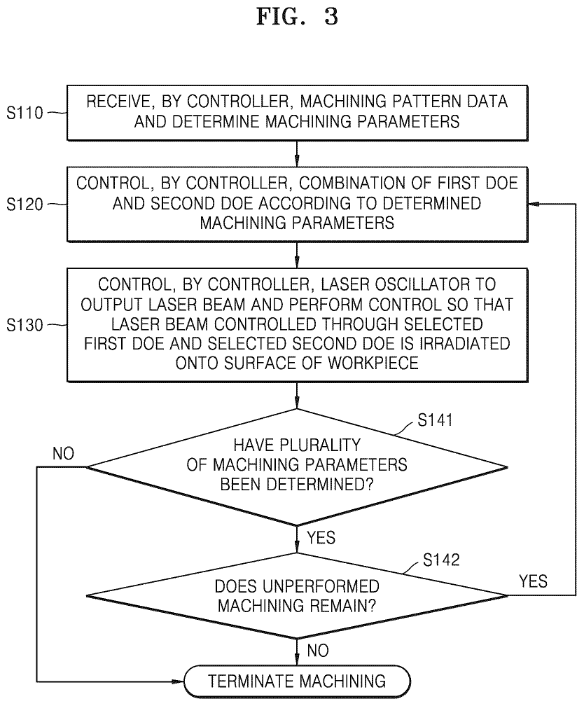

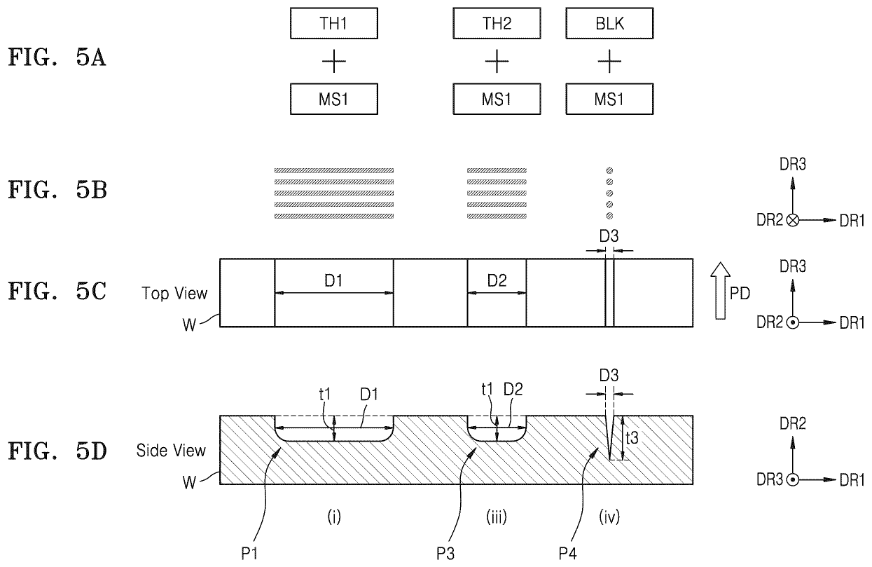

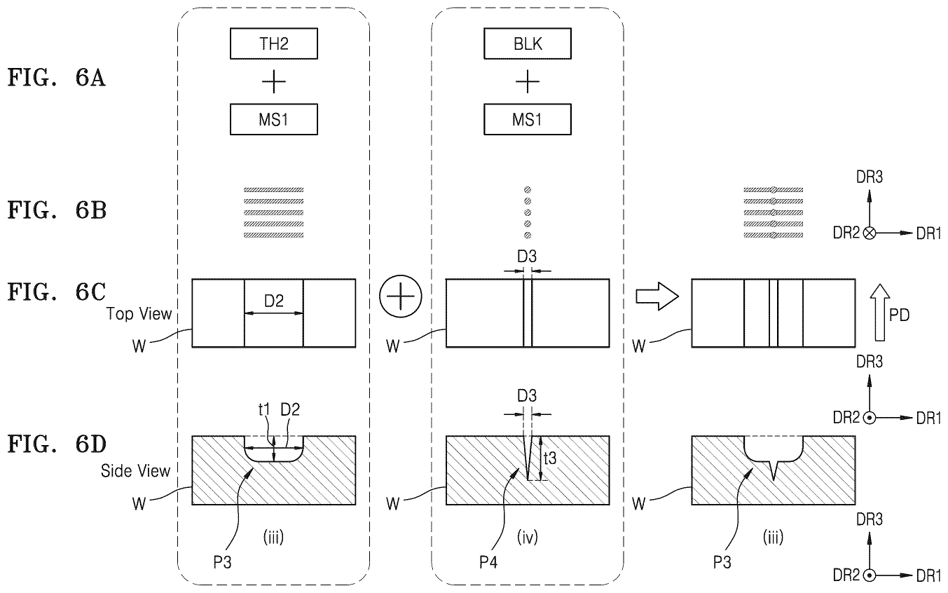

FIG. 3 is a flowchart illustrating a laser machining method using the laser machining apparatus 100 of FIG. 1. FIGS. 4A-4D are diagrams illustrating an embodiment of a laser machining method of forming various machining patterns by using the laser machining apparatus 100 of FIG. 1. FIGS. 5A-5D are diagrams illustrating another embodiment of a laser machining method of forming various machining patterns by using the laser machining apparatus 100 of FIG. 1. FIGS. 6A-6D are diagrams illustrating another embodiment of a laser machining method of forming various machining patterns by using the laser machining apparatus 100 of FIG. 1.

In each of FIGS. 4A to 6D, 4A, 5A, 6A conceptually illustrate a combination of a first DOE and a second DOE, 4B, 5B, 6B conceptually illustrate a shape of a laser beam irradiated onto a workpiece W, 4C, 5C, 6D illustrate a plane (top view) of the workpiece W machined by the laser beam of 4B, 5B, 6B, and 4D, 5D, 6D illustrate a cross-section (side view) of the workpiece W machined by the laser beam of 4B, 5B, 6B, wherein the cross-section corresponds to the plane of 4C, 5C, 6C.

Referring to FIG. 3, in operation S110, the controller 150 may receive machining pattern data and determine machining parameters.

The machining pattern data may refer to information related to the machining pattern and may include information about a machining line width of the machining pattern (indicated by a combination of D and a number in the drawings) and a machining depth (indicated by a combination of t and a number in the drawings). The machining pattern may refer to a shape of a groove, a trench, a hole, or the like formed in the workpiece W by the laser beam. The machining pattern may be defined by the machining line width and the machining depth.

The machining line width may refer to the width of the machining pattern, and may refer to the length of the machining pattern in a direction crossing the machining direction PD with the surface of the workpiece W as a reference plane. The machining direction PD may be a direction in which the laser beam and the workpiece W move relative to each other to perform machining. In the disclosure, the machining direction PD is the DR3 direction (FIG. 3). Accordingly, the machining line width may be the length of the machining pattern in the DR1 direction (FIG. 3) crossing the DR3 direction.

The machining depth may refer to the depth of the machining pattern and may refer to the length of the machining pattern in the thickness direction of the workpiece W. In the disclosure, the machining depth may be the length of the machining pattern in the negative DR2 direction.

The machining parameter may refer to the parameter of the beam to be irradiated so as to form the machining pattern. The machining parameter may include the shape of the laser beam and the number of branched beams. The machining parameter may further include the size of the laser beam, the pitch (interval) of the branched beams, and the output intensity of the laser beam.

The controller 150 may determine the machining parameters based on the machining pattern data. For example, the controller 150 may determine the machining parameters through a table in which the machining parameters are mapped according to the machining line widths and the machining depths included in the machining pattern data. In an embodiment, the machining line width may be determined based on the shape of the laser beam among the machining parameters. In some embodiments, the machining depth may be determined by the number of branched beams among the machining parameters. In case that each of the plurality of beams branched with respect to the single light source maintains the same output, the depth of irradiation of each beam may increase as the number of branched beams increases. The machining parameters may be determined by taking into account, in addition to the machining pattern data, the material and thickness of the workpiece W. However, the disclosure is not limited thereto and the machining parameters may also be determined according to a user input.

In operation S120, the controller 150 may control the combination of the first DOE and the second DOE according to the determined machining parameters. For example, the controller 150 may control the optical element holder 125 to select one first DOE (or blank BLK) from the first optical group 121 according to the shape of the laser beam of the machining parameter, select one second DOE (or blank BLK) from the second optical group 122 according to the number of branched beams of the machining parameter, align the selected DOEs (or blanks BLK) in series with respect to the optical axis of the laser beam, and combine the selected DOEs (or blanks BLK).

In some embodiments, in operation S120, the controller 150 may monitor the alignment of the selected first DOE and the selected second DOE in real time, based on the image transmitted from the camera 141 of the coaxial optical system 140, and in case that an alignment error occurs, the controller 150 may control the optical element holder 125 to modify the alignment.

In operation S130, the controller 150 may control the laser oscillator 110 to output the laser beam and may perform control so that the laser beam controlled through the selected first DOE and the selected second DOE is irradiated onto the surface of the workpiece W. In this manner, the machining pattern may be formed in the workpiece W.

In operation S141, the controller 150 may identify whether the plurality of machining parameters have been determined. In case that the plurality of machining parameters have been determined, the controller 150 may proceed to operation S142 to determine whether unperformed machining remains. In case that the unperformed machining remains, the controller 150 may return to operation S120 to perform the unperformed machining. However, in operation S141, in case that the plurality of machining parameters have not been determined, the controller 150 may terminate the machining. In some embodiments, in case that the plurality of machining parameters have been determined in operation S141, but no unperformed machining remains in operation S142, the controller 150 may terminate the machining.

Referring to FIGS. 3 and 4A-4D, the machining method using the laser machining apparatus 100 is described in detail.

FIGS. 3 and 4A-4D illustrate a method by which, in operation S120 of FIG. 3, the controller 150 selects one optical element from the first optical group 121, selects one optical element from the second optical group 122, and combines the selected optical elements to machine U-shaped machining patterns P1 and P2 having different machining depths.

First, (i) of FIGS. 4A-4D illustrates a case where the controller 150 receives first machining pattern data for machining a first machining pattern P1 having a first machining line width D1 and a first machining depth t1 in operation S110 of FIG. 3.

In operation S110 of FIG. 3, the controller 150 may receive the first machining pattern data and determine a single first machining parameter according to the input first machining pattern data.

In operation S120 of FIG. 3, the controller 150 may control the optical element holder 125 to select the first TH DOE TH1, which converts a laser beam into a line beam having a first length, from the first optical group 121 as the first DOE according to the determined first machining parameter, select the first MS DOE MS1, which branches the line beam into a first number of multiple beams, from the second optical group 122 as the second DOE, and combine the selected DOEs.

In operation S130 of FIG. 3, the controller 150 may control the laser oscillator 110 to output the laser beam. The laser beam generated by the laser oscillator 110 may be a Gaussian laser beam and may have a point shape. The laser beam may pass through the first TH DOE TH1 and may be converted into the line beam having the first length. The shape of the line beam may be defined by a length Len and a width Wid. The length Len of the line beam may be the length of the laser beam in a direction crossing the machining direction PD. For example, the length Len of the line beam in (i) of FIGS. 4A-4D may be the length in the DR1 direction. The width Wid of the line beam may be the length of the laser beam in a direction parallel to the machining direction PD. For example, the width Wid of the line beam in (i) of FIGS. 4A-4D may be the length in the DR3 direction. In some embodiments, the profile of the line beam may have a flat top-hat shape. In other words, the intensity of the laser beam above an ablation threshold is uniform. The intensity of the beam refers to the amount of energy per unit area of the laser beam, and the unit of the intensity of the beam is W/cm².

Next, the line beam having the first length may pass through the first MS DOE MS1 and may be branched into a first number of multiple beams. For example, the number (first number) of multiple beams in (i) of FIGS. 4A-4D is shown as 5, but may be 2, 3, or 4. The first MS DOE MS1 may branch the laser beam having passed through the first TH DOE TH1 into a one-dimensional beam array (1×N, where N is a first number) arranged in parallel in the machining direction PD. In this case, the individual beams constituting the multiple beams may have the same shape, size, and intensity.

Next, the controlled laser beam may pass through the lens unit 124 and may be irradiated onto the surface of the workpiece W to form the U-shaped first machining pattern P1 corresponding to the first machining pattern data on the workpiece W.

In general, the laser machining apparatus may use a low-power multi-machining method in which a low-power single beam machines the workpiece W multiple times so as to minimize thermal damage to the workpiece W and improve machining quality. However, the low-power multi-machining method using the single beam has the problem that the machining time increases and the productivity decreases because the workpiece W has to be moved and machined multiple times. However, according to an embodiment, because the second DOE branches the laser beam into multiple beams arranged in parallel in the machining direction PD, a low-power multi-machining effect may be obtained with only one irradiation. Therefore, the laser machining apparatus 100 according to an embodiment may have an effect of shortening the machining time while minimizing damage to the workpiece W.

Because only the single machining parameter is determined in operation S141 of FIG. 3, the machining is terminated.

(ii) of FIGS. 4A-4D illustrates a case where the controller 150 receives second machining pattern data for machining a second machining pattern P2 having a first machining line width D1 and a second machining depth t2 in operation S110 of FIG. 3. Compared to the first machining pattern P1 in (i) of FIGS. 4A-4D, the second machining pattern P2 in (ii) of FIGS. 4A-4D has a deeper machining depth. In other words, the second machining depth t2 is greater (deeper) than the first machining depth t1 (t1<t2).

In operation S120 of FIG. 3, the controller 150 may control the optical element holder 125 to select the first TH DOE TH1, which converts a laser beam into a line beam having a first length, from the first optical group 121 as the first DOE according to the determined second machining parameter, select the second MS DOE MS2, which branches the line beam into a second number of multiple beams, from the second optical group 122 as the second DOE, and combine the selected DOEs. The second MS DOE MS2 may branch the laser beam into a larger number of beams than the first MS DOE MS1.

In operation S130 of FIG. 3, the controller 150 may control the laser oscillator 110 to output the laser beam. The laser beam may pass through the first TH DOE TH1 and may be converted into the line beam having the first length. Next, the line beam having the first length may pass through the second MS DOE MS2 and may be converted into a second number of multiple beams, wherein the second number is greater than the first number. For example, the number (second number) of multiple beams in (ii) of FIGS. 4A-4D is shown as 8, but may be 6, 7, 9, or 10. The individual beams which constitute the multiple beams may maintain the same output. The second number of multiple beams having passed through the second MS DOE MS2 may be arranged in parallel in the machining direction PD. The controlled laser beam may pass through the lens unit 124 and may be irradiated onto the surface of the workpiece W to form the second machining pattern P2 corresponding to the second machining pattern data on the workpiece W.

Because only the single machining parameter is determined in operation S141 of FIG. 3, the controller 150 terminates the machining.

As illustrated in FIGS. 4A-4D, the controller 150 may control the machining depth by changing the combination of the DOEs selected from the first optical group 121 and the second optical group 122.

Referring to FIGS. 3 and 5A-5D, the machining method using the laser machining apparatus 100 is described in detail.

FIGS. 3 and 5A-5D illustrate a method by which, in operation S120 of FIG. 3, the controller 150 selects one optical element from the first optical group 121, selects one optical element from the second optical group 122, and combines the selected optical elements to machine machining patterns having different machining line widths.

Because (i) of FIGS. 5A-5D is the same as (i) of FIGS. 4A-4D, refer to the description provided above.

(iii) of FIGS. 5A-5D illustrates a case where the controller 150 receives third machining pattern data for machining a third machining pattern P3 having a first machining depth t1 and a second machining line width D2 less than the first machining line width D1 in operation S110 of FIG. 3. Compared to the first machining pattern P1 in (i) of FIGS. 5A-5D, the third machining pattern P3 in (iii) of FIGS. 5A-5D has a smaller machining line width. In other words, the second machining line width D2 is smaller (shorter) than the first machining line width D1 (D1>D2).

In operation S110 of FIG. 3, the controller 150 may receive the third machining pattern data and determine a third machining parameter according to the input third machining pattern data.

In operation S120 of FIG. 3, the controller 150 may control the optical element holder 125 to select the second TH DOE TH2, which converts a laser beam into a line beam having a second length less than the first length, from the first optical group 121 as the first DOE according to the determined third machining parameter, select the first MS DOE MS1, which branches the line beam into a first number of multiple beams, from the second optical group 122 as the second DOE, and combine the selected second TH DOE TH2 and the selected first MS DOE MS1. The second TH DOE TH2 may generate a line beam having a shorter length than the first TH DOE TH1.

In operation S130 of FIG. 3, the controller 150 may control the laser oscillator 110 to output the laser beam. The laser beam may pass through the second TH DOE TH2 and may be converted into the line beam having the second length. Next, the line beam having the second length may pass through the first MS DOE MS1 and may be converted into a first number of multiple beams arranged in parallel in the machining direction PD. The controlled laser beam may pass through the lens unit 124 and may be irradiated onto the surface of the workpiece W to form the third machining pattern P3 corresponding to the third machining pattern data on the workpiece W.

Because only the single machining parameter is determined in operation S141 of FIG. 3, the machining is terminated.

(iv) of FIGS. 5A-5D illustrates a case where, in operation S110 of FIG. 3, the controller 150 receives fourth machining pattern data for machining a V-shaped fourth machining pattern P4 having a third machining line width D3 less than the first machining line width D1 and the second machining line width D2 and a third machining depth t3 deeper than the first machining depth t1 and the second machining depth t2. Compared to the first machining pattern P1 and the second machining pattern P2 in (i) and (iii) of FIG. 5, the fourth machining pattern P4 in (iv) of FIGS. 5A-5D has a smaller machining line width. In other words, the third machining line width D3 is smaller (shorter) than the first machining line width D1 and the second machining line width D2. (D1, D2>D3)

In operation S110 of FIG. 3, the controller 150 may receive the fourth machining pattern data and determine a fourth machining parameter according to the input fourth machining pattern data.

In operation S120 of FIG. 3, the controller 150 may control the optical element holder 125 to select the blank BLK, which allows the laser beam to pass, from the first optical group 121 according to the determined fourth machining parameter, select the first MS DOE MS1, which branches the line beam into a first number of multiple beams, from the second optical group 122 as the second DOE, and combine the selected DOEs.

In operation S130 of FIG. 3, the controller 150 may control the laser oscillator 110 to output the laser beam. The output laser beam may be a Gaussian laser beam. After passing through the blank BLK, the laser beam may pass through the first MS DOE MS1 and may be converted into a first number of spot beams arranged in parallel in the machining direction PD. The controlled laser beam may pass through the lens unit 124 and may be irradiated onto the surface of the workpiece W to form the fourth machining pattern P4 corresponding to the fourth machining pattern data on the workpiece W.

Because only the single machining parameter is determined in operation S141 of FIG. 3, the controller 150 terminates the machining.

As illustrated in FIGS. 5A-5D, the controller 150 may control the machining line width by changing the combination of the DOEs selected from the first optical group 121 and the second optical group 122.

Referring to FIGS. 3 and 6A-6D, the machining method using the laser machining apparatus 100 is described in detail.

FIGS. 3 and 6A-6D illustrate a method of machining a combined machining pattern. The laser machining apparatus may form machining patterns having various machining line widths and machining depths, but may also machine combined machining patterns. FIG. 6 illustrates an example of a case where a plurality of machining parameters are determined.

Referring to (v) of FIGS. 6A-6D, the controller 150 may receive fifth machining pattern data in which the third machining pattern P3 and the fourth machining pattern P4 are combined in operation S110 of FIG. 3.

In operation S110 of FIG. 3, the controller 150 may analyze the fifth machining pattern data, may separate the third machining pattern data and the fourth machining pattern data, and may determine the third machining parameter for machining the third machining pattern P3 and the fourth machining parameter for machining the fourth machining pattern P4.

In operation S120 of FIG. 3, the controller 150 may control the optical element holder 125 to select the second TH DOE TH2 from the first optical group 121 according to the determined third machining parameter, select the first MS DOE MS1 from the second optical group 122, and combine the selected second TH DOE TH2 and the selected first MS DOE MS1.

In operation S130 of FIG. 3, the controller 150 may control the laser oscillator 110 to output the laser beam. The laser beam may pass through the second TH DOE TH2 and may be converted into the line beam having the second length. Next, the line beam having the second length may pass through the first MS DOE MS1 and may be converted into a first number of multiple beams arranged in parallel in the machining direction PD. The controlled laser beam may pass through the lens unit 124 and may be irradiated onto the surface of the workpiece W to form the third machining pattern P3 on the workpiece W.

Because the plurality of machining parameters have been determined in operation S141 of FIG. 3 and the machining corresponding to the fourth machining parameter has not been performed in operation S142, the controller 150 may perform operation S120 of FIG. 3 again.

In operation S120 of FIG. 3, the controller 150 may control the optical element holder 125 to select the blank BLK, which allows the laser beam to pass, from the first optical group 121 according to the determined fourth machining parameter, select the first MS DOE MS1, which branches the line beam into a first number of multiple beams, from the second optical group 122 as the second DOE, and combine the selected blank BLK and the selected first MS DOE MS1.

In operation S130 of FIG. 3, the controller 150 may control the laser oscillator 110 to output the laser beam. The output laser beam may be a Gaussian laser beam. After passing through the blank BLK, the laser beam may pass through the first MS DOE MS1 and may be converted into a first number of spot beams arranged in parallel in the machining direction PD. The controlled laser beam may pass through the lens unit 124 and may be irradiated onto the surface of the workpiece W to additionally form the fourth machining pattern P4 on a portion of the workpiece W where the third machining pattern P3 has already been formed. Accordingly, a fifth machining pattern P5, which is a combination of the third machining pattern P3 and the fourth machining pattern P4, may be formed on the workpiece W.

Because only the plurality of machining parameters have been determined in operation S141, but all machining has been performed in operation S142, the controller 150 may terminate the machining.

As illustrated in FIGS. 6A-6D, the controller 150 may change the combination of the DOEs selected from the first optical group 121 and the second optical group 122 at each machining time and may perform machining multiple times. Accordingly, various types of machining patterns may be formed by using a laser machining apparatus 100 including the single optical unit 120.

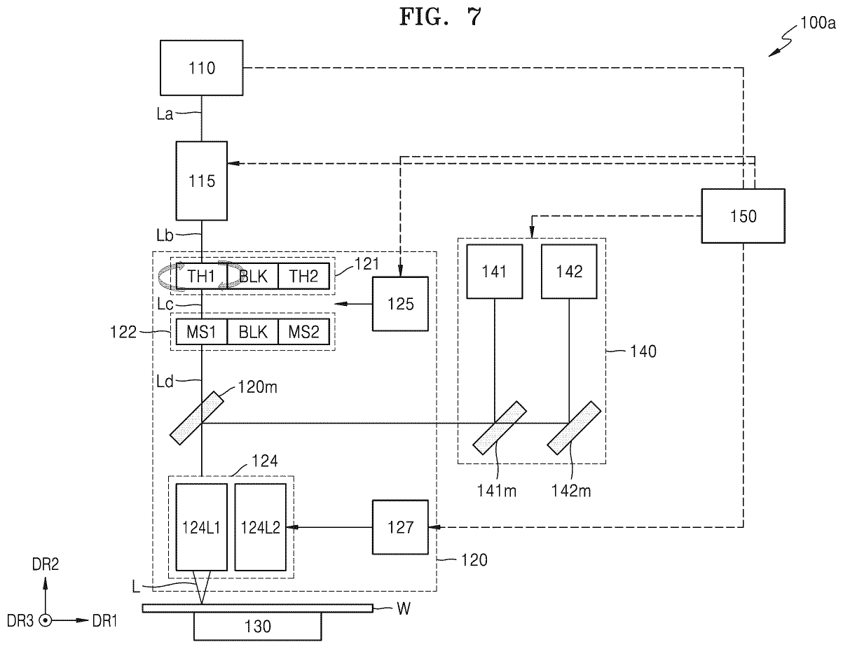

FIG. 7 is a diagram illustrating a laser machining apparatus 100a according to another embodiment.

The laser machining apparatus 100a of FIG. 7 differs from the laser machining apparatus 100 of FIG. 1 in terms of the lens unit 124. Hereinafter, the lens unit 124 is mainly described, and the description of the laser machining apparatus of FIG. 1 is equally applied to the other components.

The lens unit 124 may include a plurality of objective lenses 124L1 and 124L2 and a lens holder 127.

The lens unit 124 may include the plurality of objective lenses 124L1 and 124L2 having different magnifications. Although FIG. 7 illustrates two objective lenses 124L1 and 124L2, more objective lenses (for example, three or four objective lenses) may be included. For example, the first objective lens 124L1 may have a 5× magnification which reduces the laser beam to ⅕, and the second objective lens 124L2 may have a 10× magnification which reduces the laser beam to 1/10. Because the lens unit 124 includes objective lenses with various magnifications, the laser machining apparatus 100a may selectively implement desired beam sizes according to machining conditions.

The lens holder 127 may select one of the plurality of objective lenses 124L1 and 124L2. For example, the lens holder 127 may select one of the plurality of objective lenses 124L1 and 124L2 and may arrange the selected objective lenses in series with the DOEs with respect to the optical axis and combine the selected objective lenses and the DOEs. The lens holder 127 may be controlled by signals which are generated by the controller 150. Similar to the optical element holder 125 illustrated in FIG. 1, the lens holder 127 may include a rotating turret or a sliding mechanism.

The laser machining apparatus 100a may combine objective lenses through the lens holder 127 in addition to different types of DOEs within the single optical unit 120. Therefore, the laser machining apparatus 100a according to an embodiment may form various machining pattern line widths and depths with the single optical unit 120.

Next, the laser machining apparatus of FIG. 7 differs from the laser machining apparatus of FIG. 1 in that the first DOE selected from the first optical group 121 is rotatable. Hereinafter, the rotating operation of the first DOE is mainly described, and the description of the laser machining apparatus of FIG. 1 is equally applied to the other components.

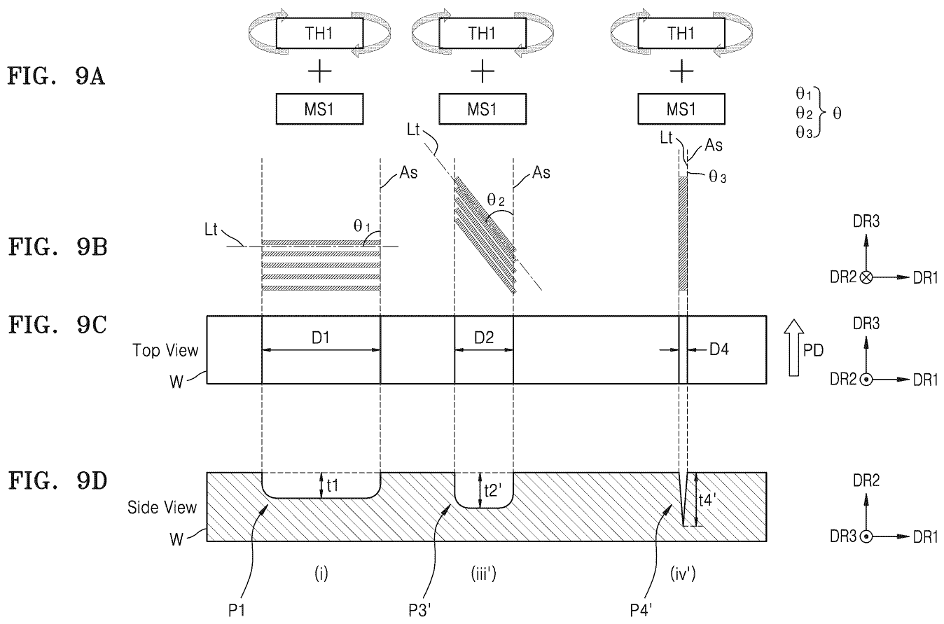

Referring to FIG. 7, the controller 150 may control the optical element holder 125 to determine a rotation angle (θ, FIGS. 9A-9D) of the first DOE selected according to the input machining pattern data, and to rotate the first DOE with respect to a rotation axis parallel to a normal line of the plane of the workpiece W according to the determined rotation angle θ. The rotation axis may coincide with the optical axis.

In this case, the optical element holder 125 may further include a mechanism for rotating the DOE, such as a hollow motor.

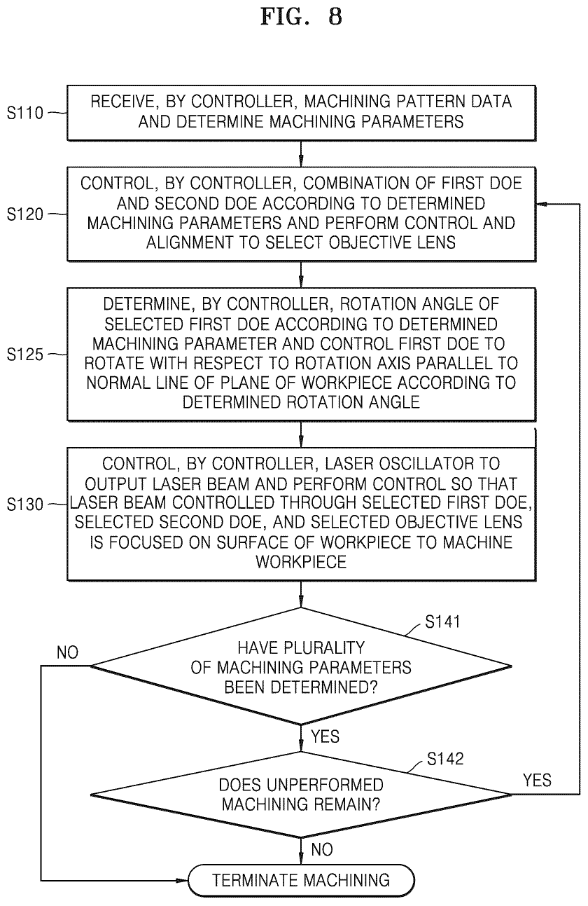

FIG. 8 is a flowchart illustrating a laser machining method using the laser machining apparatus 100a of FIG. 7. FIGS. 9A-9D is a diagram illustrating an embodiment of a laser machining method of forming various machining patterns by using the laser machining apparatus 100a of FIG. 7.

In FIGS. 9A-9D, FIG. 9A conceptually illustrates a combination of a first DOE and a second DOE, FIG. 9B conceptually illustrates a shape of a laser beam irradiated onto a workpiece W, FIG. 9C illustrates a plane (top view) of the workpiece W machined by the laser beam of FIG. 9B, and FIG. 9D illustrates a cross-section (side view) of the workpiece W machined by the laser beam of FIG. 9B, wherein the cross-section corresponds to the plane of FIG. 9C.

Referring to FIGS. 8 and 9A-9D, in operation S110, the controller 150 may receive machining pattern data and determine a machining parameter.

In operation S120, the controller 150 may control the combination of the first DOE and the second DOE according to the determined machining parameter. In some embodiments, the controller 150 may select an objective lens from the lens unit 124 according to the determined machining parameter. For example, the controller 150 may control the optical element holder 125 to select one first DOE from the first optical group 121 according to the shape of the laser beam of the machining parameter, select one second DOE from the second optical group 122 according to the number of branched beams of the machining parameter, select an objective lens according to the size of the laser beam of the machining parameter, align the selected DOEs and the selected objective lens in series with respect to the optical axis of the laser beam, and combine the selected DOEs and the selected objective lens.

In some embodiments, in operation S120, the controller 150 may monitor the alignment of the selected first DOE, the selected second DOE, and the selected objective lens in real time, based on the image transmitted from the camera 141 of the coaxial optical system 140, and in case that an alignment error occurs, the controller 150 may control the optical element holder 125 and the lens holder 127 to modify the alignment.

In operation S125, the controller 150 may determine the rotation angle θ of the selected first DOE according to the determined machining parameter and may control the first DOE to rotate with respect to a rotation axis parallel to a normal line of the plane of the workpiece W according to the determined rotation angle θ.

The rotation angle θ may refer to an angle at which the first DOE located opposite the surface of the workpiece W is rotated with respect to the workpiece W. The rotation angle θ may be defined based on a positional relationship between the workpiece W and the laser beam to be irradiated onto the workpiece W.

In an embodiment, referring to FIG. 9A-9D, the rotation angle θ may refer to an angle formed between a parallel axis Lt parallel to the linear beam and a reference axis As parallel to the machining direction PD (the third direction DR3) crossing the machining line width in case that the laser beam irradiated onto the workpiece W has the narrowest machining line width with respect to the workpiece W. In other words, as illustrated in (iv′) of FIGS. 9A-9D, in case that the parallel axis Lt is parallel to the reference axis As, the rotation angle θ may be defined as about 0°, and as illustrated in (i) of FIGS. 9A-9D, in case that the parallel axis Lt is perpendicular to the reference axis As, the rotation angle may be defined as about 90°. In an embodiment, the rotation angle θ may be selected between 0°, which corresponds to a case where the parallel axis Lt is parallel to the reference axis As, and 90°, which corresponds to a case where the parallel axis Lt is perpendicular to the reference axis As.

The rotation angle θ may be defined in a different manner from that of the embodiment of FIGS. 9A-9D. The following description is given focusing on the definition of the rotation angle θ according to the embodiment of FIGS. 9A-9D.

In some embodiments, the first DOE may be rotated to change the linear arrangement direction of the laser beam irradiated onto the workpiece W. The rotation angle θ may be defined as a first angle in case that the linear arrangement direction of the laser beam corresponds to the machining of the narrowest machining line width, and may be defined as a second angle in case that the linear arrangement direction of the laser beam corresponds to the machining of the widest machining line width. The first angle may be about 0°and the second angle may be about 90°, but the disclosure is not limited thereto.

The controller 150 may determine a smaller rotation angle θ (a rotation angle close to about 0°) as the machining line width is narrower and the machining depth is deeper, and may determine a larger rotation angle θ (a rotation angle close to about 90°) as the machining line width is wider and the machining depth is shallower. This is because the linear arrangement direction of the laser beam changes depending on the rotation angle, and thus, the machining line width changes, and the energy density of the laser beam irradiated onto the workpiece W changes depending on a change in the linear arrangement direction of the laser beam, and thus, the machining depth changes.

Operations S130, S141, and S142 are described below with reference to FIGS. 9A-9D.

Referring to FIGS. 8 and 9A-9D, the machining method using the laser machining apparatus 100a is described in detail.

FIGS. 8 and 9A-9D illustrate a method by which, in operation S125 of FIG. 8, the controller 150 rotates the first DOE with respect to the rotation axis according to the determined rotation angle θ to form machining patterns having different machining line widths and machining depths according to the rotation angle θ of the first DOE, even when using the same combination of the first DOE and the second DOE.

(i) of FIGS. 9A-9D illustrates a case where the first DOE is rotated by a first rotation angle θ1 (about 90°). A first machining pattern P1 has a first machining line width D1 and a first machining depth t1. Because (i) of FIGS. 9A-9D is similar to (i) of FIGS. 5A-5D, refer to the description provided above.

(iii′) of FIGS. 9A-9D illustrates a case where the first DOE is rotated by a second rotation angle θ2 (between about 0°and about 90°).

Referring to FIGS. 9A-9D, in operation S110 of FIG. 8, the controller 150 may receive 3′-th machining pattern data and determine a 3′-th machining parameter according to the input 3′-th machining pattern data.

In operation S120 of FIG. 8, the controller 150 may control the optical element holder 125 to select the first TH DOE TH1 from the first optical group 121 as the first DOE according to the determined 3′-th machining parameter, select the first MS DOE MS1 from the second optical group 122 as the second DOE, and combine the selected first TH DOE TH1 and the selected first MS DOE MS1.

In operation S125 of FIG. 8, the controller 150 may control the optical element holder 125 to determine the rotation angle θ of the first TH DOE TH1 to be the second rotation angle θ2 less than the first rotation angle θ1 according to the determined 3′-th machining parameter, and to rotate the first TH DOE TH1 with respect to the rotation axis parallel to the normal line of the plane of the workpiece W according to the determined second rotation angle θ2.

In operation S130 of FIG. 8, the controller 150 may control the laser oscillator 110 to output the laser beam. The laser beam may pass through the first TH DOE TH1 rotated by the second rotation angle θ2 and may be converted into the line beam having the first length. The line beam may be a line beam, the direction of which is controlled by the second rotation angle θ2. Next, the line beam may pass through the first MS DOE MS1 and may be converted into a first number of multiple beams arranged in parallel in the machining direction PD. The direction of the multiple beams may also be controlled by the second rotation angle θ2. The controlled laser beam may pass through the selected objective lens so that the size thereof is controlled, and may be irradiated onto the surface of the workpiece W to form a 3′-th machining pattern P3′ corresponding to the 3′-th machining pattern data on the workpiece W. The 3′-th machining pattern P3′ has a second machining line width D2 less than the first machining line width D1 and a 2′-th machining depth t2′ greater (deeper) than the first machining depth.

Because only the single machining parameter is determined in operation S141 of FIG. 3, the machining is terminated.

The first machining pattern P1 and the 3′-th machining pattern P3′ in FIGS. 9A-9D have the same machining parameter, except for the rotation angle θ. When comparing the first machining pattern P1 by the beam having the first rotation angle θ1 with the 3′-th machining pattern P3′ by the beam having the second rotation angle θ2, the machining line width is greater in case that the rotation angle θ is larger, and the machining depth is smaller (shallower) in case that the rotation angle θ is larger.

(iv′) of FIGS. 9A-9D illustrates a case where the first DOE is rotated by a third rotation angle θ3 (about 0°).

Referring to FIGS. 9A-9D, in operation S110 of FIG. 8, the controller 150 may receive 4′-th machining pattern data and determine a 4′-th machining parameter according to the input 4′-th machining pattern data.

In operation S120 of FIG. 8, the controller 150 may control the optical element holder 125 to select the first TH DOE TH1 from the first optical group 121 as the first DOE according to the determined 4′-th machining parameter, select the first MS DOE MS1 from the second optical group 122 as the second DOE, and combine the selected first TH DOE TH1 and the selected first MS DOE MS1.

In operation S125 of FIG. 8, the controller 150 may control the optical element holder 125 to determine the rotation angle θ of the first TH DOE TH1 to be the third rotation angle θ3 less than the second rotation angle θ2 according to the determined 4′-th machining parameter, and to rotate the first TH DOE TH1 with respect to the rotation axis parallel to the normal line of the plane of the workpiece W according to the determined third rotation angle θ3.

In operation S130 of FIG. 8, the controller 150 may control the laser oscillator 110 to output the laser beam. The laser beam may pass through the first TH DOE TH1 and may be converted into the line beam having the first length. The line beam may be a line beam, the direction of which is controlled by the third rotation angle θ3. Next, the line beam may pass through the first MS DOE MS1 and may be converted into a first number of multiple beams arranged in parallel in the machining direction PD. The direction of the multiple beams may also be controlled by the third rotation angle θ3. The controlled laser beam may pass through the selected objective lens so that the size thereof is controlled, and may be irradiated onto the surface of the workpiece W to form a 4′-th machining pattern P4′ corresponding to the 4′-th machining pattern data on the workpiece W. The 4′-th machining pattern P4′ has a fourth machining line width D4 less than the second machining line width D2 and a 4′-th machining depth t4′ greater (deeper) than the second machining depth.

Because only the single machining parameter is determined in operation S141 of FIG. 8, the machining is terminated.

The 3′-th machining pattern P3′ and the 4′-th machining pattern P4′ in FIGS. 9A-9D have the same machining parameter, except for the rotation angle θ. When comparing the 3′-th machining pattern P3′ by the beam having the second rotation angle θ2 with the 4′-th machining pattern P4′ by the beam having the third rotation angle θ3, the machining line width is greater in case that the rotation angle θ is larger, and the machining depth is smaller (shallower) in case that the rotation angle θ is larger.

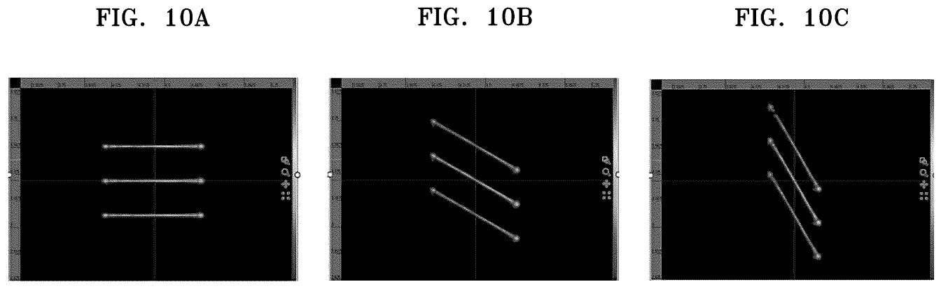

FIGS. 10A-10C are images obtained by capturing rotation of a laser beam by the laser machining apparatus 100a of FIG. 7.

Referring to FIGS. 10A-10C, it may be confirmed that the pitch (interval) of the multiple laser beams decreases as the rotation angle decreases. FIG. 10A illustrates a case where the rotation angle is close to about 90°, FIG. 10B illustrates a case where the rotation angle is between about 90°and about 0°, and FIG. 10C illustrates a case where the rotation angle is close to about 0°. Therefore, in case that the rotation angle θ is about 0°, the beam pitch becomes a minimum value, and multiple beams completely overlap each other as in (iv′) of FIGS. 9A-9D.

As illustrated in FIGS. 9A-9D, the controller 150 may control the machining depth and the machining line width by rotating the first DOE, in addition to changing the combination of the DOEs selected from the first optical group 121 and the second optical group 122.

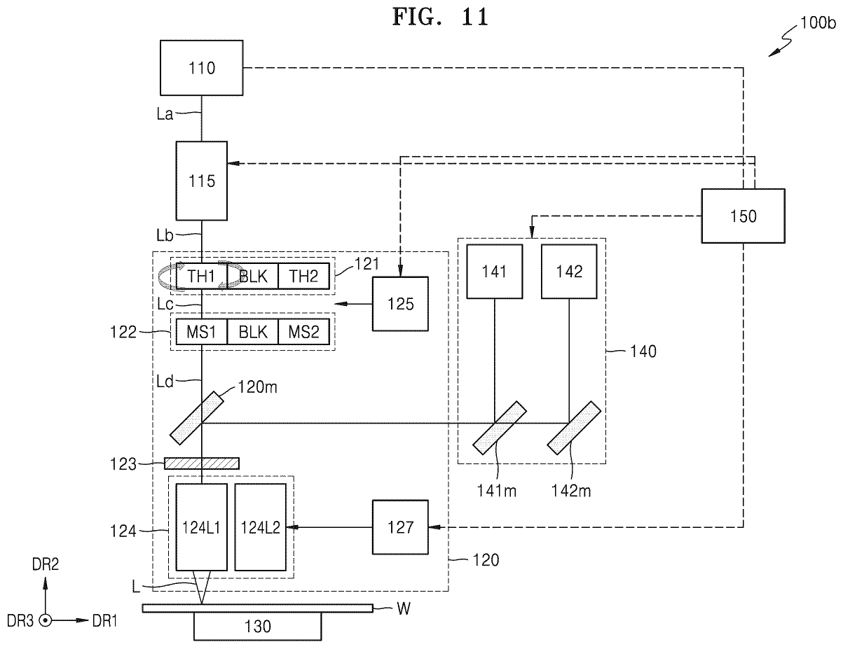

FIG. 11 Is a diagram illustrating a laser machining apparatus 100b according to another embodiment.

The laser machining apparatus 100b of FIG. 11 differs from the laser machining apparatus 100a in that the laser machining apparatus 100b of FIG. 11 further includes a beam limiting element 123. Hereinafter, the beam limiting element 123 is mainly described, and the description of the laser machining apparatus 100a of FIG. 7 is equally applied to the other components.

The beam limiting element 123 may be arranged between a selected second DOE and a selected objective lens. The beam limiting element 123 may generate a partially blocked laser beam by blocking a portion of a laser beam which is controlled by a combination of a selected first DOE and a selected second DOE. The beam limiting element 123 may be a slit or an aperture, but the disclosure is not limited thereto, and any element may be used as the beam limiting element 123 as long as the element is capable of blocking a portion of the laser beam.

A controller 150 may control the beam limiting element 123 to control a laser beam blocking ratio of the beam limiting element 123, based on a rotation angle θ, so as to machine a workpiece W to a constant machining depth, despite the rotation angle θ of the first DOE. In some embodiments, the controller 150 may control the beam limiting element 123 in synchronization with the rotation angle θ.

For example, the controller 150 may control the beam limiting element 123 to increase the laser beam blocking ratio as the size of the rotation angle θ decreases (closer to 0°), and to decrease the laser beam blocking ratio as the size of the rotation angle θ increases (closer to 90°). In other words, the controller 150 may increase the laser beam blocking ratio as the machining line width of the machining pattern becomes narrower, and may decrease the laser beam blocking ratio as the machining line width of the machining pattern becomes wider, thereby machining the workpiece W to a uniform machining depth.

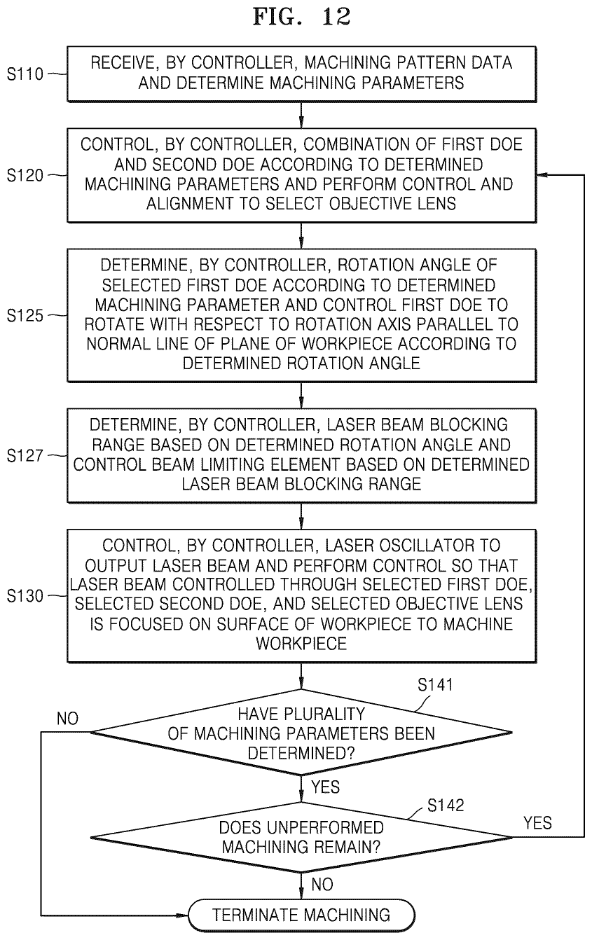

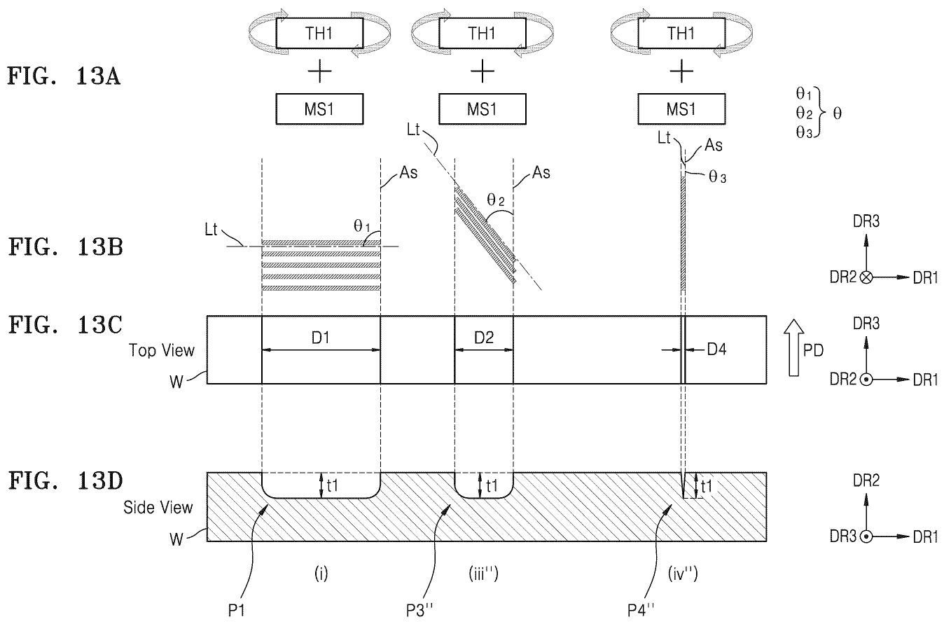

FIG. 12 is a flowchart illustrating a laser machining method using the laser machining apparatus 100b of FIG. 11. FIGS. 13A-13D is a diagram illustrating an embodiment of a laser machining method of forming various machining patterns by using the laser machining apparatus 100b of FIG. 11.

In FIGS. 13A-13D, FIG. 13A conceptually illustrates a combination of a first DOE and a second DOE, FIG. 13B conceptually illustrates a shape of a laser beam irradiated onto a workpiece W, FIG. 13C illustrates a plane (top view) of the workpiece W machined by the laser beam of FIG. 13B, and FIG. 13D illustrates a cross-section (side view) of the workpiece W machined by the laser beam of FIG. 13B, wherein the cross-section corresponds to the plane of FIG. 13C.

Referring to FIGS. 12 and 13A-13D, in operation S110, the controller 150 may receive machining pattern data and determine a machining parameter.

In operation S120, the controller 150 may control an optical element holder 125 to select one first DOE from a first optical group 121 according to a shape of a laser beam of the machining parameter, select one second DOE from a second optical group 122 according to the number of branched beams of the machining parameter, select an objective lens according to the size of the laser beam of the machining parameter, align the selected first DOE, the selected second DOE, and the selected objective lens in series with respect to the optical axis of the laser beam, and combine the selected first DOE, the selected second DOE, and the selected objective lens.

In some embodiments, in operation S120, the controller 150 may monitor the alignment of the selected first DOE, the selected second DOE, and the selected objective lens in real time, based on an image transmitted from a camera 141 of an coaxial optical system 140, and in case that an alignment error occurs, the controller 150 may control the optical element holder 125 and the lens holder 127 to modify the alignment.

In operation S125, the controller 150 may determine the rotation angle θ of the selected first DOE according to the determined machining parameter and may control the first DOE to rotate with respect to a rotation axis parallel to a normal line of the plane of the workpiece W according to the determined rotation angle θ.

In operation S127, the controller 150 may determine a laser beam blocking range based on the determined rotation angle θ and may control the beam limiting element 123 based on the determined laser beam blocking range.

Referring again to (i) and (iii′) of FIGS. 9A-9D, the workpiece W is machined to the second machining line width D2 narrower than the first machining line width D1 and the second machining depth t2′ deeper than the first machining depth t1 at the second rotation angle θ2 less than the first rotation angle θ1. This is because the power and machining speed of the laser beam may be constant, but in case that the direction of the laser beam changes, the machining line width may narrow and the energy density per unit area of the laser beam transmitted to the narrowed machining line width may increase.

In another embodiment, the controller 150 of the laser machining apparatus 100b may constantly maintain the energy density per unit area transmitted to the workpiece W by controlling the laser beam blocking ratio of the beam limiting element 123 in synchronization with the rotation angle θ of the first DOE. Accordingly, the laser machining apparatus 100b may maintain a constant machining depth even in case that the workpiece W is machined to various machining line widths. In FIGS. 13A-13D, it may be confirmed that the machining depths at a first rotation angle θ1, a second rotation angle θ2, and a third rotation angle θ3 are equal to a first machining depth t1, but the machining line widths for the rotation angles θ1, θ2, and θ3 are respectively a first machining line width D1, a second machining line width D2, and a fourth machining line width D4, which are different from each other.

Operations S130, S141, and S142 are described below with reference to FIG. 13.

Referring to FIGS. 12 and 13A-13D, the machining method using the laser machining apparatus 100b is described in detail.

FIGS. 12 and 13A-13D illustrate a method by which, in operation S127 of FIG. 12, the controller 150 rotates the first DOE with respect to the rotation axis according to the determined rotation angle θ, but the beam limiting element 123 blocks the beam in conjunction with the rotation angle θ so that, even when the same combination of the first DOE and the second DOE is used, the machining patterns having different machining line widths but constant machining depths are machined according to the rotation angle θ of the first DOE.

(i) of FIGS. 13A-13D illustrates a case where the first DOE is rotated by the first rotation angle θ1 (about 90°). A first machining pattern P1 has a first machining line width D1 and a first machining depth t1. Because (i) of FIG. 13 is the same as (i) of FIGS. 9A-9D, refer to the description provided above.

(iii′) of FIGS. 13A-13D illustrates a case where the first DOE is rotated by the second rotation angle θ2 (between about 0°and about 90°) and the beam is limited according to the second rotation angle θ2.

Referring to FIGS. 13A-13D, in operation S110 of FIG. 12, the controller 150 may receive 3″-th machining pattern data and determine a 3″-th machining parameter according to the input 3″-th machining pattern data.

In operation S120 of FIG. 12, the controller 150 may control the optical element holder 125 to select the first TH DOE TH1 from the first optical group 121 as the first DOE according to the determined 3″-th machining parameter, select the first MS DOE MS1 from the second optical group 122 as the second DOE, and combine the selected first TH DOE TH1 and the selected first MS DOE MS1.

In operation S125 of FIG. 12, the controller 150 may control the optical element holder 125 to determine the rotation angle θ of the first TH DOE TH1 to be the second rotation angle θ2 less than the first rotation angle θ1 according to the determined 3″-th machining parameter, and to rotate the first TH DOE TH1 with respect to the rotation axis parallel to the normal line of the plane of the workpiece W according to the determined second rotation angle θ2.

In operation S127 of FIG. 12, the controller 150 may determine the laser beam blocking range as a second blocking range according to the determined second rotation angle θ2 and control the beam limiting element 123 based on the second blocking range.

In operation S130 of FIG. 12, the controller 150 may control the laser oscillator 110 to output the laser beam. The laser beam may pass through the first TH DOE TH1 and may be converted into the line beam having the first length. The line beam may be a line beam, the direction of which is controlled by the second rotation angle θ2. Next, the line beam may pass through the first MS DOE MS1 and may be converted into a first number of multiple beams arranged in parallel in the machining direction PD. The direction of the multiple beams may also be controlled by the second rotation angle θ2. In some embodiments, the controlled multiple beams may be blocked according to the second blocking range. Therefore, the number of multiple beams may be less than the first number according to the second blocking range. The controlled laser beam may pass through the selected objective lens so that the size thereof is controlled, and may be irradiated onto the surface of the workpiece W to form a 3″-th machining pattern P3″ corresponding to the 3″-th machining pattern data on the workpiece W. The 3″-th machining pattern P3″ has the second machining line width D2 less than the first machining line width D1, but has the first machining depth t1 equal to the first machining depth t1.

Because only the single machining parameter is determined in operation S141 of FIG. 12, the machining is terminated.

The 3″-th machining pattern P3″ of FIG. 12 has the same machining parameter as that of the 3′-th machining pattern P3′ of FIGS. 9A-9D, except for the beam blocking range. The 3″-th machining pattern P3″ of FIG. 12 and the 3′-th machining pattern P3′ of FIGS. 9A-9D have the same machining line width and different machining depths. In other words, the 3″-th machining pattern P3″ of FIG. 12, which is machined based on the second blocking range corresponding to the second rotation angle θ2, has a machining depth less (shallower) than the 3′-th machining pattern P3′ of FIGS. 9A-9D.

(iv″) of FIGS. 13A-13D illustrates a case where the first DOE is rotated by a third rotation angle θ3 (about 0°) and the beam is limited according to the third rotation angle θ3.

Referring to FIGS. 13A-13D, in operation S110 of FIG. 12, the controller 150 may receive 4″-th machining pattern data and determine a 4″-th machining parameter according to the input 4″-th machining pattern data.

In operation S120 of FIG. 12, the controller 150 may control the optical element holder 125 to select the first TH DOE TH1 from the first optical group 121 as the first DOE according to the determined 4″-th machining parameter, select the first MS DOE MS1 from the second optical group 122 as the second DOE, and combine the selected first TH DOE TH1 and the selected first MS DOE MS1.

In operation S125 of FIG. 12, the controller 150 may control the optical element holder 125 to determine the rotation angle θ of the first TH DOE TH1 to be the third rotation angle θ3 less than the second rotation angle θ2 according to the determined 4″-th machining parameter, and to rotate the first TH DOE TH1 with respect to the rotation axis parallel to the normal line of the plane of the workpiece W according to the determined third rotation angle θ3.

In operation S127 of FIG. 12, the controller 150 may determine the laser beam blocking range as a third blocking range according to the determined third rotation angle θ3 and control the beam limiting element 123 based on the third blocking range.

In operation S130 of FIG. 12, the controller 150 may control the laser oscillator 110 to output the laser beam. The laser beam may pass through the first TH DOE TH1 and may be converted into the line beam having the first length. The line beam may be a line beam, the direction of which is controlled by the third rotation angle θ3. Next, the line beam may pass through the first MS DOE MS1 and may be converted into a first number of multiple beams arranged in parallel in the machining direction PD. The direction of the multiple beams may also be controlled by the third rotation angle θ3. In some embodiments, the controlled multiple beams may be blocked according to the third blocking range. Therefore, the number of multiple beams may be less than the first number according to the third blocking range. The controlled laser beam may pass through the selected objective lens so that the size thereof is controlled, and may be irradiated onto the surface of the workpiece W to form a 4″-th machining pattern P4″ corresponding to the 4″-th machining pattern data on the workpiece W. The 4″-th machining pattern P4″ has the fourth machining line width D4 less than the second machining line width D2, but has the first machining depth t1 equal to the first machining depth t1.

Because only the single machining parameter is determined in operation S141 of FIG. 12, the machining is terminated.

The 4″-th machining pattern P4″ of FIG. 12 has the same machining parameter as that of the 4′-th machining pattern P4′ of FIGS. 9A-9D, except for the beam blocking range. The 4″-th machining pattern P4″ of FIG. 12 and the 4′-th machining pattern P3′ of FIGS. 9A-9D have the same machining line width and different machining depths. In other words, the 4″-th machining pattern P4″ of FIG. 12, which is machined to have the third blocking range corresponding to the third rotation angle θ3, has a machining depth less (shallower) than the 4′-th machining pattern P4′ of FIGS. 9A-9D.

In the laser machining apparatus and the laser machining method using the same according to embodiments, various machining processes may be performed by controlling the machining line widths and machining depths without changing the optical unit included in the laser machining apparatus. Furthermore, various machining specifications may be satisfied without changing the optical unit, which contributes to simplifying and stabilizing process conditions.

According to the disclosure, various machining processes may be performed by controlling the machining line widths and machining depths without changing the optical unit included in the laser machining apparatus.

The shape of the laser beam irradiated onto the workpiece and the number of branched beams may be changed through a selective combination of doctrine of equivalents within the single optical unit, which enables the machining line width and machining depth of the machining pattern to be variously formed.

Furthermore, various machining specifications may be satisfied without changing the optical unit, which contributes to simplifying and stabilizing process conditions.

Embodiments according to the disclosure may be implemented in the form of a computer program which may be executed through various elements on a computer, and such a computer program may be recorded on a computer-readable medium. At this time, the medium may include a magnetic medium such as hard disk, floppy disk, and magnetic tape, an optical recording medium such as CD-ROM and DVD, a magneto-optical medium such as floptical disks, and hardware devices specially configured to store and execute program instructions, such as ROM, RAM, or flash memory.

The computer program may be specially designed and configured for the disclosure or may be known and available to those of ordinary skill in the art of computer software. Examples of the computer program may include not only machine language code generated by a compiler but also high-level language code that is executable using an interpreter or the like by a computer.

According to an embodiment, the methods according to various embodiments of the disclosure may be provided by being included in a computer program product. The computer program product may be traded between a seller and a buyer as commodities. The computer program product may be distributed in the form of a machine-readable storage medium (for example, CD-ROM), or may be distributed (for example, downloaded or uploaded) online, either via an application store (for example, Play Store™) or directly between two user devices. In the case of the online distribution, at least part of the computer program product may be stored at least temporarily on a machine-readable storage medium, such as a server of a manufacturer, a server of an application store, or a memory of a relay server, or may be temporarily generated.

The use of any and all examples or exemplary terms (e.g., “such as”) provided herein is simply intended to describe the disclosure in detail, and the scope of the disclosure is not limited by the examples or exemplary terms unless otherwise claimed. In addition, it will be understood by those of ordinary skill in the art that various modifications, combinations and changes may be made according to design conditions and factors within the scope of the appended claims or equivalents thereof.

Therefore, it will be understood that the spirit of the disclosure should not be limited to the embodiments described above, and the claims and all equivalent modifications fall within the scope of the disclosure.

What is claimed is:

1. A laser machining apparatus for forming various machining patterns with a single optical unit, the laser machining apparatus comprising:
a laser oscillator configured to generate a laser beam;
an optical unit configured to control the laser beam and irradiate the controlled laser beam onto a surface of a workpiece, the optical unit comprising:
a first optical group comprising a plurality of first diffractive optical elements configured to convert a shape of the laser beam;
a second optical group comprising a plurality of second diffractive optical elements configured to branch the laser beam into multiple beams;
an optical element holder configured to select a diffractive optical element from each of the first optical group and the second optical group, arrange the selected diffractive optical elements in series with respect to an optical axis of the laser beam, and combine the diffractive optical elements; and
a lens unit configured to focus the laser beam on the surface of the workpiece;
a machining table configured to move the workpiece in a machining direction; and
a controller configured to control the optical element holder to receive machining pattern data, determine a machining parameter according to the input machining pattern data, and select a combination of the first diffractive optical element and the second diffractive optical element corresponding to the determined machining parameter.

2. The laser machining apparatus of claim 1, further comprising a laser attenuator configured to control output intensity of the laser beam.

3. The laser machining apparatus of claim 1, wherein the first optical group further comprises a blank configured to allow the laser beam to pass, and
the plurality of first diffractive optical elements comprise a top-hat diffractive optical element configured to convert the laser beam into at least one of a line shape, a rectangle shape, or a square shape.

4. The laser machining apparatus of claim 1, wherein the second optical group further comprises a blank configured to allow the laser beam to pass, and
the plurality of second diffractive optical elements comprise a multi-spot diffractive optical element configured to branch the laser beam into multiple beams and differently implement a number of multiple beams.

5. The laser machining apparatus of claim 1, wherein the optical element holder comprises a rotating turret or a sliding mechanism capable of selectively arranging the diffractive optical elements of the first optical group and the second optical group.

6. The laser machining apparatus of claim 1, wherein the lens unit comprises a plurality of objective lenses having different magnifications,
the laser machining apparatus further comprises a lens holder configured to arrange an objective lens selected from the lens unit in series with the selected diffractive optical elements with respect to an optical axis and combine the objective lens and the selected diffractive optical elements, and
the controller is further configured to control the lens holder to select an objective lens corresponding to the determined machining parameter.

7. The laser machining apparatus of claim 6, wherein the plurality of objective lenses comprise at least an objective lens having a 5× magnification and an objective lens having a 10× magnification.

8. The laser machining apparatus of claim 1, wherein the machining pattern data comprises a machining line width and a machining depth, and
the machining parameter comprises at least a shape of the laser beam and a number of multiple beams.

9. The laser machining apparatus of claim 1, wherein the controller is further configured to determine a rotation angle of the first diffractive optical element selected according to the input machining pattern data, and control the first diffractive optical element to rotate with respect to a rotation axis parallel to a normal line of a plane of the workpiece according to the determined rotation angle.

10. The laser machining apparatus of claim 9, further comprising a beam limiting element arranged between the first optical group and the lens unit and configured to block a portion of the laser beam,
wherein the beam limiting element comprises a slit or an aperture, and
the controller is further configured to determine a laser beam blocking range based on the rotation angle and control the beam limiting element based on the determined laser beam blocking range.

11. The laser machining apparatus of claim 1, further comprising a camera configured to obtain a real-time image through a same path as a path along which the laser beam is irradiated.

12. A laser machining method using the laser machining apparatus of claim 1, the laser machining method comprising:
a) receiving machining pattern data and determining a machining parameter, by the controller;
b) controlling, by the controller, a combination of a first diffractive optical element and a second diffractive optical element according to the machining parameter; and
c) controlling the laser oscillator to output a laser beam and forming a machining pattern on the workpiece by performing control so that the laser beam controlled through the selected first diffractive optical element and the selected second diffractive optical element is irradiated onto the surface of the workpiece W, by the controller.

13. The laser machining method of claim 12, wherein, in case that, in operation a), the controller receives first machining pattern data for machining a first machining pattern having a first machining line width and a first machining depth, the controller is configured to, in operation b), control the optical element holder to select a first top-hat diffractive optical element, which converts the laser beam into a line beam having a first length, as the first diffractive optical element, select a first multi-spot diffractive optical element, which branches the line beam into a first number of multiple beams, as the second diffractive optical element, and combine the selected first top-hat diffractive optical element and the first multi-spot diffractive optical element, and
the multiple beams are arranged in parallel in a machining direction.

14. The laser machining method of claim 13, wherein, in case that, in operation a), the controller receives second machining pattern data for machining a second machining pattern having a first machining line width and a second machining depth different from the first machining depth, the controller is further configured to, in operation b), control the optical element holder to select a first top-hat diffractive optical element, which converts the laser beam into a line beam having a first length, as the first diffractive optical element, select a second multi-spot diffractive optical element, which branches the line beam into a second number of multiple beams, as the second diffractive optical element, and combine the selected first top-hat diffractive optical element and the second multi-spot diffractive optical element, and
the second number is different from the first number.

15. The laser machining method of claim 13, wherein, in case that, in operation a), the controller receives third machining pattern data for machining a third machining pattern having a second machining line width different from the first machining line width and the first machining depth, the controller is further configured to, in operation b), control the optical element holder to select a second top-hat diffractive optical element, which converts the laser beam into a line beam having a second length, as the first diffractive optical element, select a first multi-spot diffractive optical element, which branches the line beam into a first number of multiple beams, as the second diffractive optical element, and combine the selected second top-hat diffractive optical element and the first multi-spot diffractive optical element, and
the second length is different from the first length.

16. The laser machining method of claim 13, wherein, in case that, in operation a), the controller receives fourth machining pattern data for machining a fourth machining pattern having a third machining line width less than the first machining line width and a third machining depth greater than the first machining depth, the controller is further configured to, in operation b), control the optical element holder to select a blank, which allows the laser beam to pass, from the first optical group, select a first multi-spot diffractive optical element, which branches the line beam into a first number of multiple beams, as the second diffractive optical element, and combine the selected blank and the selected first multi-spot diffractive optical element.

17. The laser machining method of claim 12, wherein a lens unit comprises a plurality of objective lenses having different magnifications,
the laser machining apparatus further comprises a lens holder configured to arrange an objective lens selected from the lens unit in series with the selected diffractive optical elements with respect to an optical axis and combine the objective lens and the selected diffractive optical elements, and
the laser machining method further comprises, in operation b), performing, by the controller, control to select an objective lens according to the machining parameter.

18. The laser machining method of claim 12, further comprising determining a rotation angle of the first diffractive optical element selected according to the input machining pattern data, and controlling the first diffractive optical element to rotate with respect to a rotation axis parallel to a normal line of a plane of a workpiece according to the determined rotation angle, by the controller.

19. The laser machining method of claim 18, wherein the laser machining apparatus further comprises a beam limiting element arranged between the first optical group and the lens unit and configured to block a portion of the laser beam, and
the laser machining method further comprises determining a laser beam blocking range based on the rotation angle and controlling the beam limiting element based on the determined laser beam blocking range, by the controller.

20. The laser machining method of claim 12, wherein the laser machining apparatus further comprises a camera configured to obtain a real-time image through a same path as a path along which the laser beam is irradiated, and
the laser machining method further comprises identifying, by the controller, alignment of the first diffractive optical element and the second diffractive optical element in real time.
